(19) United States
(12) Patent Application Publication
(10) Pub. No.: US 2011/0252365 A1
(43) Pub. Date: Oct. 13, 2011

(54) Display system and method for zooming document file

(75) Inventors: Chaucer Chiu, Taipei (TW); Jinbei Shen, Shanghai (CN)

(73) Assignee: INVENTEC CORPORATION, Taipei (TW)

(21) Appl. No.: 12/662,752

(22) Filed: May 3, 2010

(30) Foreign Application Priority Data
Apr. 8, 2010 (TW) 099110850

(51) Int. Cl. G06F 3/048

(52) U.S. Cl. 715/800

(57) ABSTRACT

A display system and method for zooming document file contents obtains the original data of a document file according to the file path of the document file. The display parameter of the original data of the document file is set according to a zoom ratio to obtained zoom data. The zoom data are then decoded into display contents using an appropriate decoding method. Thus, contents of different document files can be zoomed differently.

### BACKGROUND OF THE INVENTION

1. Field of Invention

The invention relates to a zoom display system and method. In particular, the invention pertains to a display system and its method for zooming by decoding different document files and zooming the contents thereof differently.

2. Related Art

With great progress in electronic technology, various kinds of aid tools have been invented. For example, when a user initiates the default magnifier in an operation system (OS), the OS opens a display region at the very top of the screen. The image around the cursor is immediately zoomed and displayed in the display region according to the zoom ratio designated by the user. The user can then view the zoomed image and operate therein.

The above-mentioned magnifier extracts a portion of the screen, which is centered at the mouse cursor, as its original image and magnifies it to show in the display region. This zooming method zooms an image extracted from the screen, whether it contains text or image information. It is then zoomed in the way of zooming an image.

However, the above-mentioned method may result in distortion if the original contents are in text or image of a specific format. That is, the zoomed image somewhat deviates from the original contents. In this case, the user may have trouble comprehending the zoomed contents, which is definitely not a goal of zooming.

In summary, the prior art always has the problem of image distortion when extracting screen images and magnifying them. It is therefore imperative to provide a better technique to solve it.

### SUMMARY OF THE INVENTION

In view of the foregoing, the invention discloses a display system and method for zooming document file contents.

The disclosed display system for zooming document file contents runs as a routine in an OS. It includes: a path extracting module, a receiving module, a zooming module, a decoding module, a cursor extracting module, a display processing module, and a displaying module.

The path extracting module extracts the file path of the document file to be processed. The receiving module receives a zoom command. After the zooming module receives the zoom command, it obtains the original data of the document file according to the file path thereof. It further sets the display parameter of the original data of the document file according to the zoom ratio in order to obtain zoom data. The decoding module selects an appropriate decoding method for the document file, and decodes the zoom data into display contents. The cursor extracting module extracts the cursor location in the document file, and finds the display location of the display contents corresponding to the cursor location. The display processing module selects a display range using the display location, and extracts the display contents in the display region as extracted contents. The displaying module shows a zoom window at the cursor location using the size of the display region, and displays the extracted content in the zoom window.

The display system for zooming document file contents includes further a setting module for setting the zoom ratio according to a zoom parameter. The zoom parameter is received by the receiving module. The zoom display system further includes a moving module for changing the display location according to a moving parameter. The moving parameter is received by the receiving module.

The disclosed display method for zooming document file contents runs routinely in an OS and includes the following steps.

First, the file path of a document is extracted. Afterwards, a zoom command is received. After the zoom command is received, the original data in the document file are obtained following the file path thereof. The display parameter of the original data in the document file is set according to the zoom ratio, thereby obtaining the zoom data. A decoding method for the document file is selected to decode the zoom data into display contents. Afterwards, the cursor location in the document file is extracted. The display location of display contents corresponding to the cursor location is determined. The display location is used to select a display range. The display contents in the display range are correspondingly retrieved as the extraction contents. Finally, a zoom window of the size of the display range is shown at the cursor location. The zoom window shows the extraction contents.

The disclosed zoom display method further includes the step of receiving a zoom parameter and setting the zoom ratio according to the zoom parameter. The disclosed method also includes the step of receiving a moving parameter and changing the display location according to the moving parameter.

As described above, the invention differs from the prior art in the following aspects. The invention obtains the zoom data by setting the display parameter in the original data of a document file directly according to the zoom ratio. An appropriate decoding method for the document file is used to decode the zoom data into display contents. Since the original data of the document file are directly zoomed, the invention can zoom differently for different document files. This prevents distortion of the original data in the document file after zooming.

Using the above-mentioned technique, the invention achieves the goal of performing different zooms for contents of different document files.

### BRIEF DESCRIPTION OF THE DRAWINGS

The invention will become more fully understood from the detailed description given herein below illustration only, and thus is not limitative of the present invention, and wherein:

FIG. 1 is a block diagram of the display system for zooming document file contents according to the invention;

FIG. 2 is a flowchart of the display method for zooming document file contents according to the invention;

FIG. 3 is a schematic view of the GUI in the OS for zooming document file contents according to the invention;

FIG. 4A is a schematic view of the document file contents after zooming according to the invention;

FIG. 4B is a schematic view of the zoom contents displayed by the invention;

FIG. 5 is a schematic view of the display result interface according to the invention;

FIG. 6 is a schematic view of the display result interface after zoom ratio adjustment according to the invention; and

FIGS. 7A and 7B are schematic views showing how the display location moves according to the invention.

### DETAILED DESCRIPTION OF THE INVENTION

The present invention will be apparent from the following detailed description, which proceeds with reference to the accompanying drawings, wherein the same references relate to the same elements.

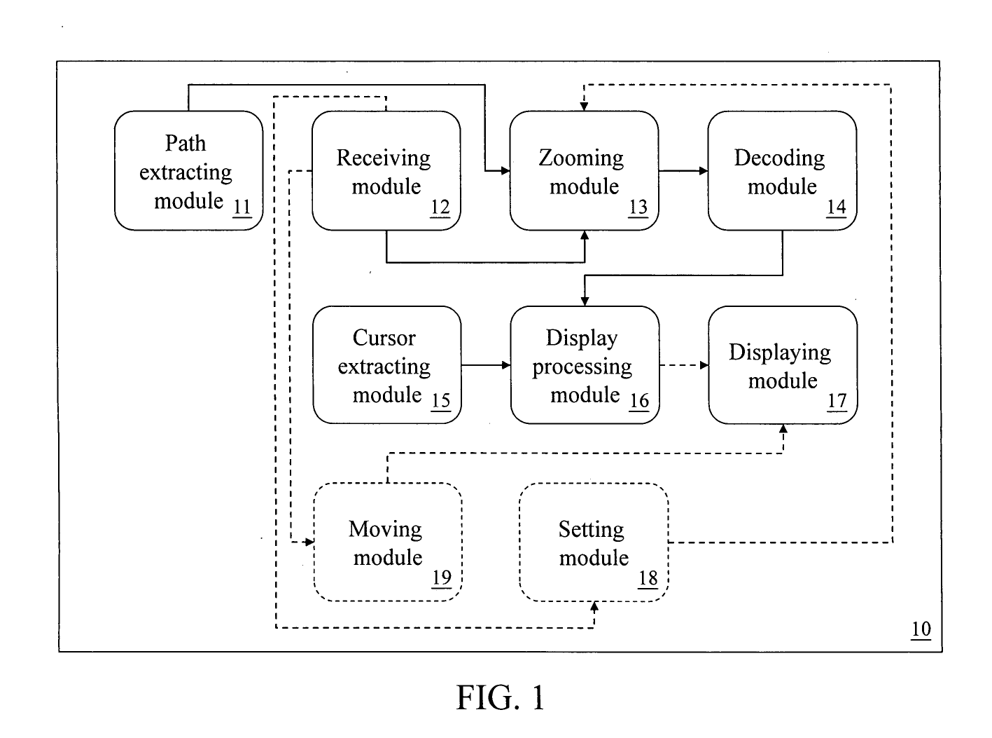

The following paragraphs first describe a display system for zooming contents of a document file according to the invention. FIG. 1 is a system block diagram of the disclosed zoom display system.

The zoom display system 10 runs routinely in an OS. It includes: a path extracting module 11, a receiving module 12, a zooming module 13, a decoding module 14, a cursor extracting module 15, a display processing module 16, and a displaying module 17.

The disclosed zoom display system 10 runs routinely in the OS. That is, it is the so-called terminate and stay resident (TSR). The usual TSR often has a routine icon shown in the routine display region. When a user clicks the routine icon, it often starts some specific function or settings of the TSR.

Due to the properties of TSR, the path extracting module 11 extracts the path of the document file when the user opens it in the OS.

Afterwards, when the user clicks the routine icon corresponding to the zoom display system 10 in the routine display region of the OS, the receiving module 12 immediately receives a zoom command. This means that the user wants to zoom the contents of the document file. After the receiving module 12 receives the zoom command, the zooming module 13 obtains the original data of the document file following the file path extracted by the path extracting module 11. It further sets the display parameter of the original data of the document file according to the zoom ratio, thereby obtaining zoom data.

Generally speaking, the original data of the document file are divided into a contents part and a display part. The contents part refers to the text or picture contents of the document file. The display part indicates how the text or picture part of the document file should be displayed. That is, the display parameter is used to set the format, font style, font size, and picture size of the text or picture contents.

Therefore, the zooming module 13 sets the display parameter of the original data of the document file using the zoom ratio. That is, the display parameter is used to zoom the fonts and the picture as well.

After the zooming module 13 obtains the zoom data by setting the display parameter of the original data of the document file according to the zoom ratio, the decoding module 14 selects an appropriate decoding method for the document file and decodes the zoom data into display contents. Since each type of document file has its own format, different decoding methods are required. Suppose the document file is created using Microsoft Office. Then the document file should be decoded using the Microsoft Office decoding method. The zoom data are then decoded into display contents to be viewed by the user.

More explicitly, suppose the document file opened by a user is ‘abc.doc’ and the file path thereof is ‘C:\abc.doc’. First, the path extracting module 11 extracts the file path of the document file ‘abc.doc’ to be ‘C:\abc.doc’. Afterwards, when the user wants to zoom the document file as he or she clicks the routine icon corresponding to the zoom display system 10 in the routine display region of the OS, the receiving module 12 receives a zoom command.

After the receiving module 12 receives the zoom command, the zooming module 13 follows the file path ‘C:\abc.doc’ of the document file ‘abc.doc’ to obtain part of the original data thereof as ‘16pt control’. It further uses the zoom ratio ‘2’ to set the display parameter ‘16pt’ of the original data of the document file ‘abc.doc’ as ‘32pt’.

Afterwards, the decoding module 14 uses the decoding method of Microsoft Office to decode the zoom data ‘32pt control’ into display contents. The display contents are ‘control’ in the font size of ‘32pt’ to be viewed by the user.

The above-mentioned zoom ratio is preset by the zoom display system 10. Therefore, the receiving module 12 further receives a setting parameter to be entered by the user. When the receiving module 12 receives the setting parameter, the setting module 18 in the zoom display system 10 performs the setting on the zoom ratio according to the setting parameter. This changes the default zoom ratio of the zoom display system 10.

Afterwards, the cursor extracting module 15 extracts the cursor location in the document file and finds the location of the display contents corresponding to the cursor location. Afterwards, the display processing module 16 selects the display range using the display location, extracting the display contents in the selected display range as the extraction contents. The extraction contents obtained by the display processing module 16 are those to be zoomed.

Finally, the display module 17 displays a zoom window of the size of the display range at the cursor location of the document file. The zoom window shows the extraction contents obtained by the display processing module 16. The user thus obtains the contents to be zoomed at the cursor location of the document file.

The zoom display system 10 can further include a moving module 19 for changing the display location of the display contents. The display location of the display contents is set according to the moving parameter received by the receiving module 12. This changes the display location of the zoom window. At the same time, the corresponding extraction contents are obtained and displayed. The moving parameter can be a time and displacement variable. That is, the zoom window moves according to the time and displacement. The extraction contents are obtained and displayed according to time. This only serves as an example, and should not be used to restrict the scope of the invention.

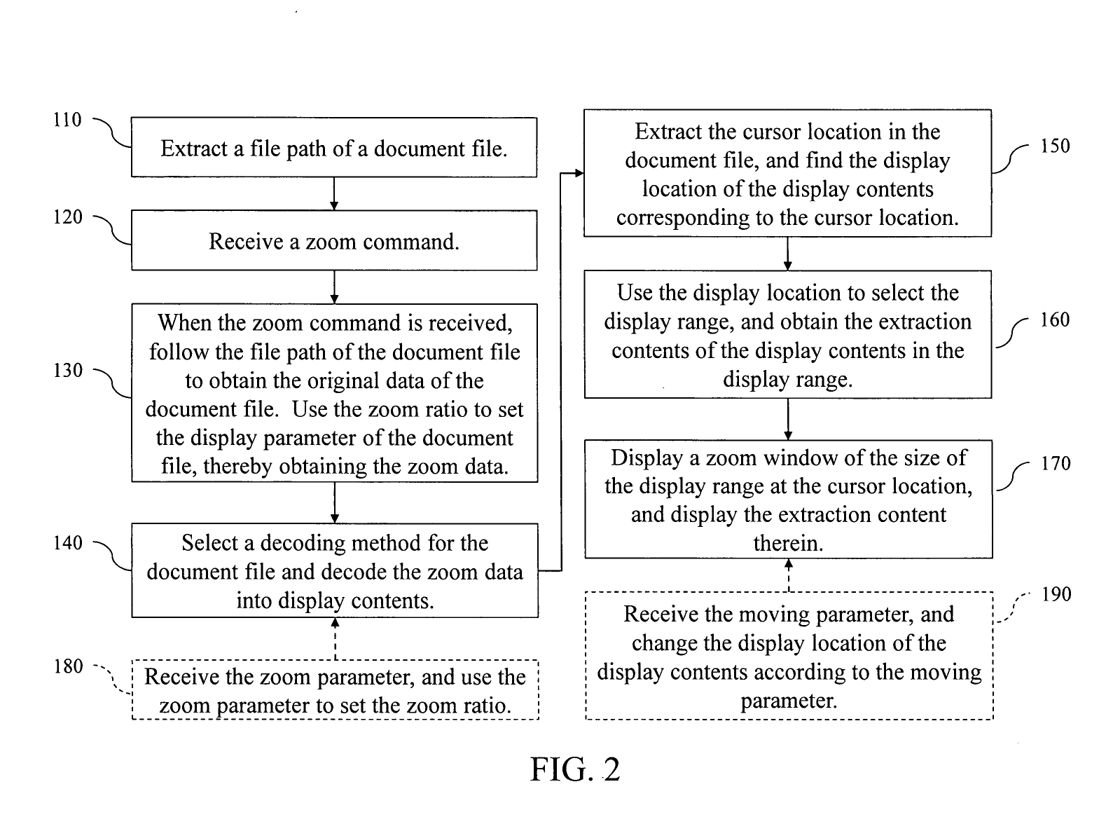

The following paragraphs use one embodiment to explain the operation and procedure of the invention, with reference to FIGS. 1 and 2. FIG. 2 is a flowchart of the disclosed display method for zooming the contents of a document file.

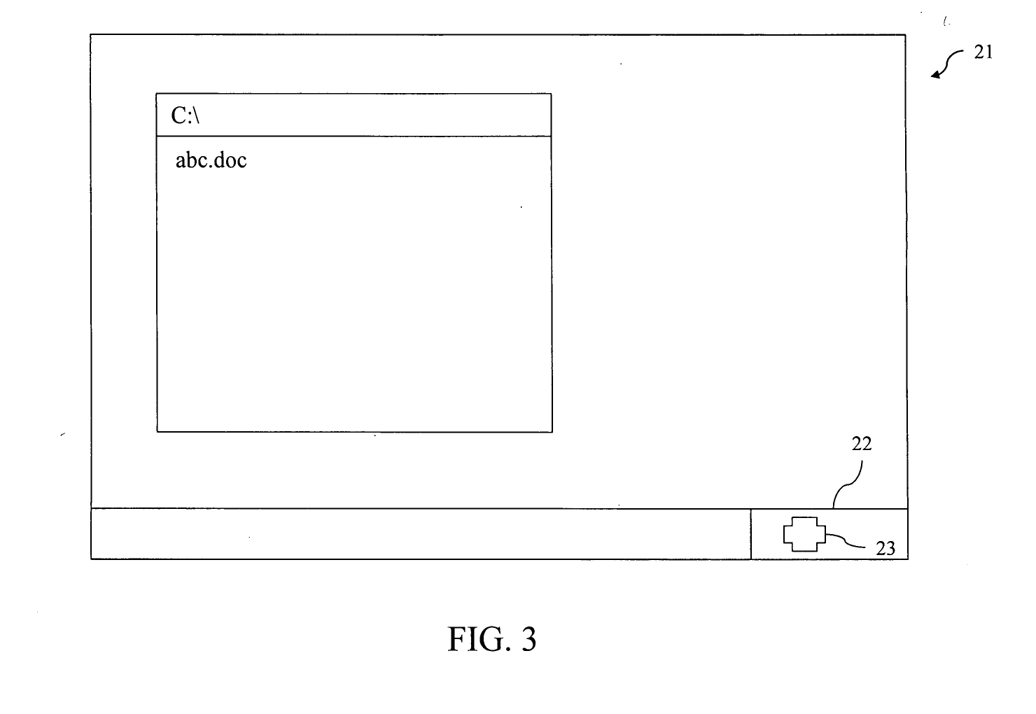

Please refer to FIG. 3, which is a schematic view of the GUI in the OS according to the invention. The disclosed zoom display system 10 runs routinely in the OS 21. A routine icon 23 is shown in the routine display region 22 of the OS 21. The path extracting module 11 extracts the file path of the document file when the user opens it in the OS.

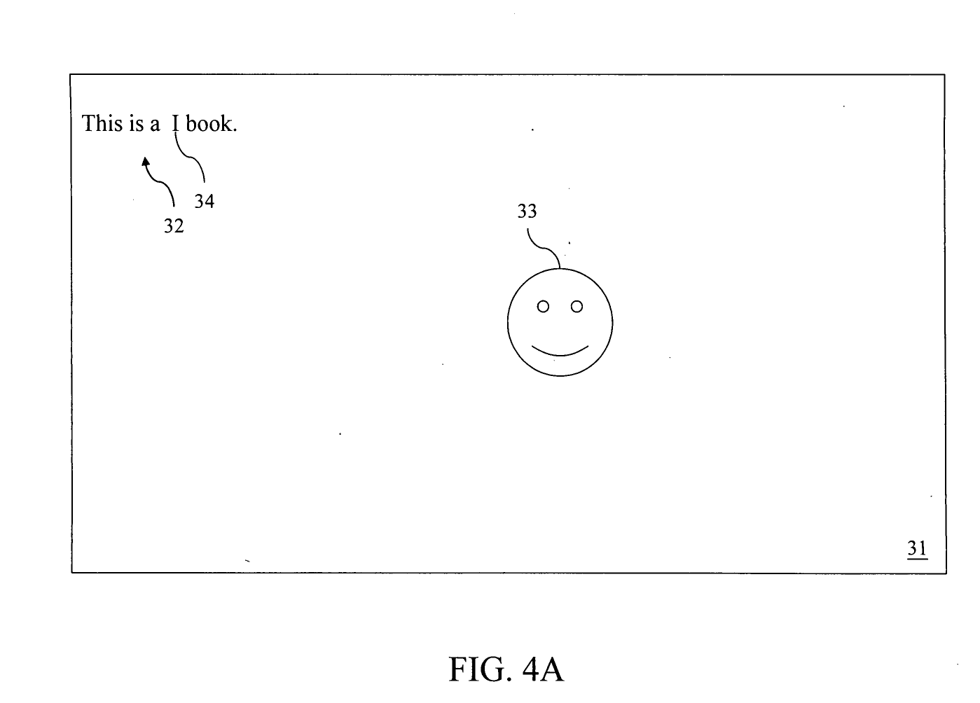

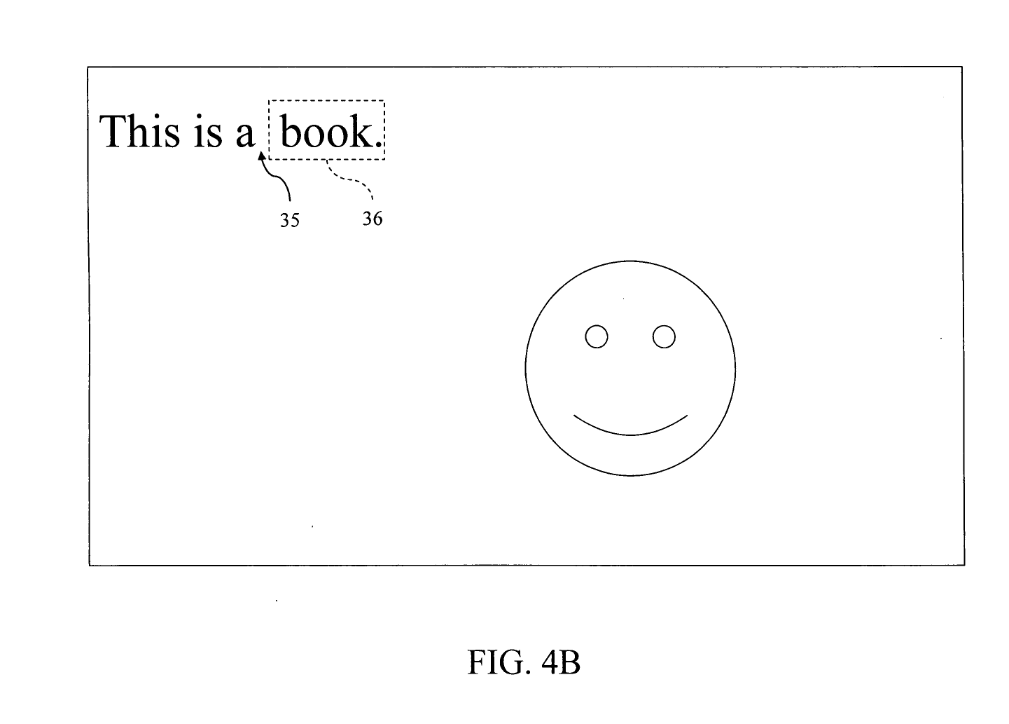

Please refer to FIG. 4A, which is a schematic view of the zoomed contents of a document file. Suppose a user opens the document file 31 ‘abc.doc’ using the file path ‘C:\abc.doc’. The document file 31 ‘abc.doc’ contains the text content 32 ‘This is a book.’ and the picture content 33 (see FIG. 4A). In this case, the path extracting module 11 extracts the file path ‘C:\abc.doc’ of the document file ‘abc.doc’ (step 110).

When the user wants to zoom the document file ‘abc.doc’ as he or she clicks the routine icon 23 corresponding to the zoom display system 10 in the routine display region 22 of the OS 21 (FIG. 3), the receiving module 12 receives a zoom command (step 120).

After the receiving module 12 receives the zoom command, the zooming module 13 follows the file path ‘C:\abc.doc’ of the document file 31 ‘abc.doc’ to obtain the original data of the document file as ‘16pt This is a book.’ and ‘100×100 picture content 33’. In particular, ‘16pt’ and ‘100×100’ are display parameters of the original data. They are only an example of the invention, and should not be used to restrict the scope thereof.

Afterwards, the display parameter ‘16pt’ of the original data of the document file is set as ‘32pt’ according to the zoom ratio ‘2’. As to ‘100×100 picture content 33’, its display parameter can be set using some existing picture zooming technology, such as interpolation, extrapolation, etc. ‘100×100 picture content 33’ can thus be turned into ‘200×200 picture content 33’ (step 130). The above-mentioned picture zooming technique is only one example. All existing picture zooming techniques should be included in the invention, and should not be used to restrict the applications thereof.

After the zooming module 13 uses the zoom ratio ‘2’ to set the display parameter of the original data of the document file and obtains the zoom data ‘32pt This is a book.’ and ‘200×200 picture content 33’, the decoding module 14 selects the decoding method corresponding to the document file 31 ‘abc.doc’ (i.e. the Microsoft Office decoding method) to decode the zoom data ‘32pt This is a book.’ and ‘200×200 picture content 33’ into the display contents (step 140). The display result is illustrated in FIG. 4B, which is a schematic view of the zoomed contents of the document file according to the invention.

Please refer simultaneously to FIGS. 4A and 4B. The cursor extracting module 15 extracts the location of the word ‘book’ at the cursor location 34 in the document file 31. It further finds the display location 35 of the display contents corresponding to the cursor location 34 in the document file 31 (step 150).

After the cursor extracting module 15 finds the display location 35 corresponding to the cursor location 34, the display processing module 16 selects a display range 36 according to the display location. In this embodiment, the display range 36 selected by the display processing module 16 is the range of one word or one picture after the display location 35. Alternatively, the display processing module 16 selects the display range 36 centered on the display location 35. These are only a couple of examples, and are not meant to restrict the scope of the invention. The first word ‘book’ after the display location 35 is selected by the display processing module 16 as the display range 36, thereby extracting the word ‘book’ in the selected zoom range 36 as the extraction content ‘book’ (step 160). The extraction content ‘book’ extracted by the display processing module 16 is the content to be zoomed.

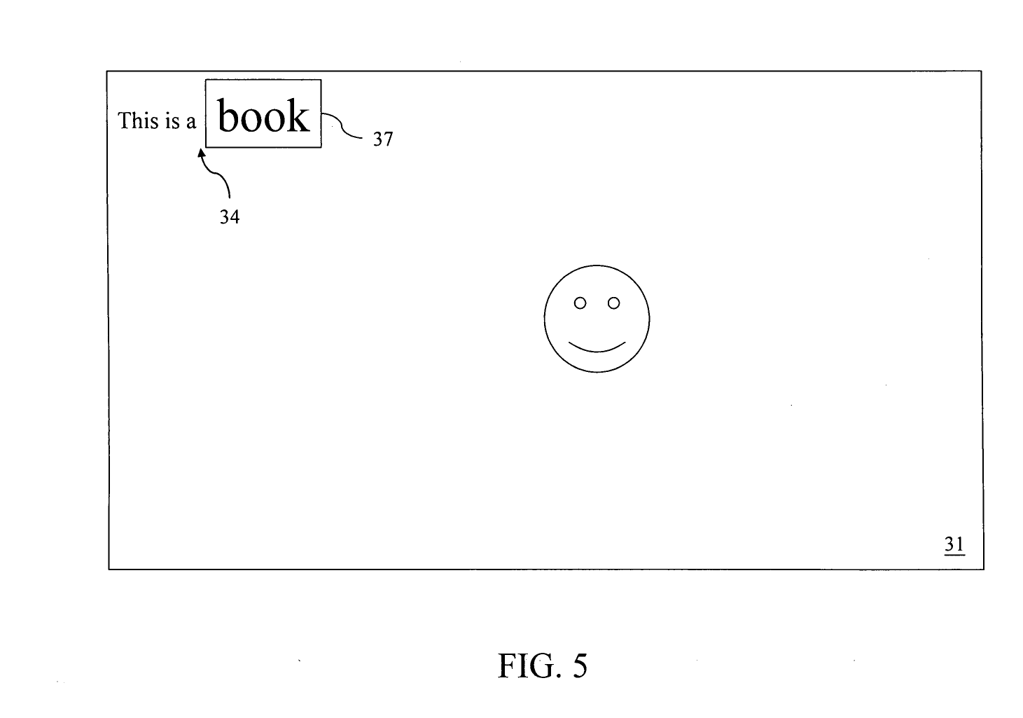

Finally, please refer to FIG. 5, which is a schematic view of the display interface according to the invention. The display module 17 displays a zoom window 37 of the size of the display range 36 at the cursor location 34 of the document file. The extraction content ‘book’ found by the display processing module 16 is then displayed in the zoom window 37 shown by the display module 17 (step 170). The user then obtains the zoomed contents at the cursor location 34 of the document file.

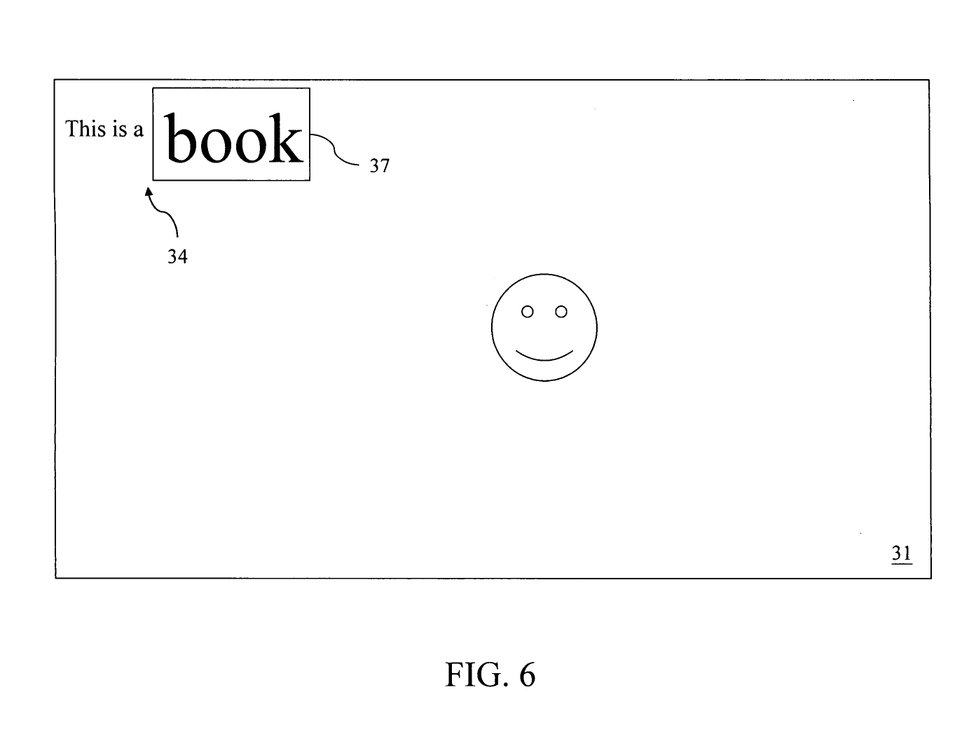

The zoom ratio is preset by the zoom display system 10. The receiving module 12 further receives a setting parameter ‘3’. The zoom display system 10 can further includes a setting module 18. Through the setting module 18, the setting parameter ‘3’ received by the receiving module 12 is used to set the zoom ratio (step 180). That is, the zoom ratio is set as ‘3’ to change the default zoom ratio of the zoom display system 10. The displayed result is shown in FIG. 6, which is a schematic of display result interface after the zoom ratio adjustment.

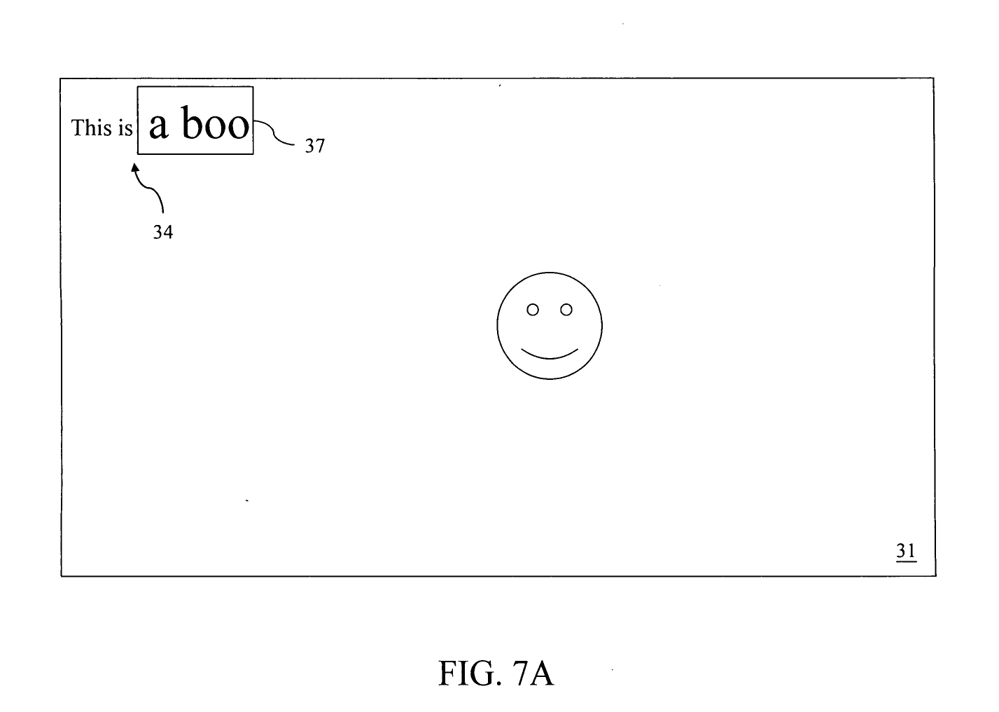

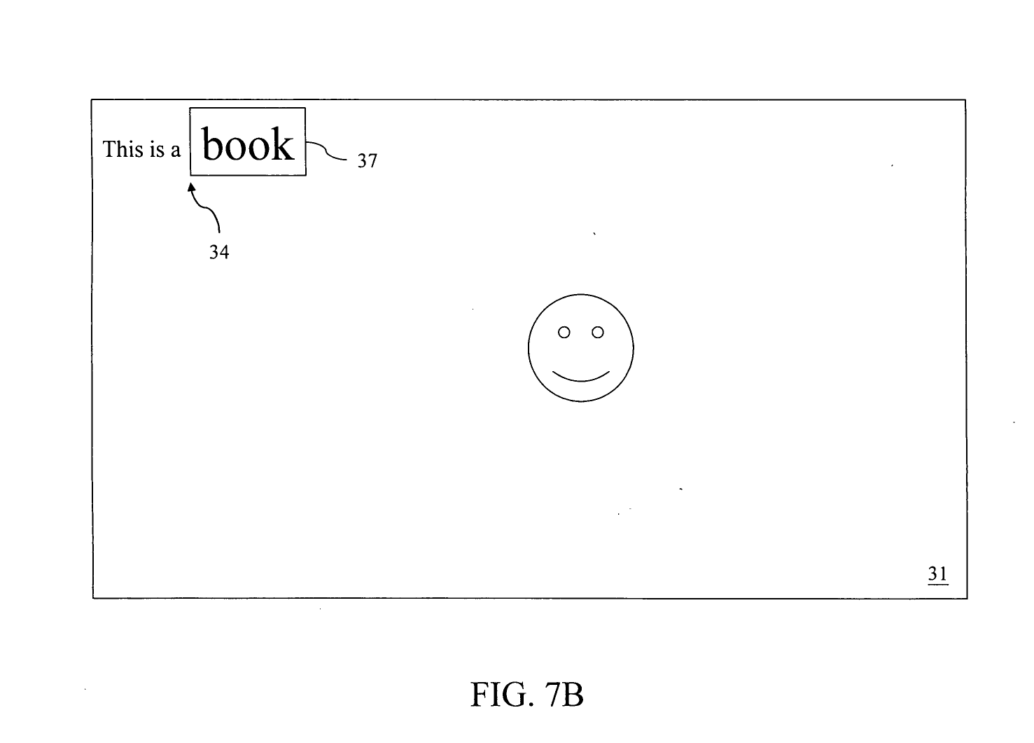

Please refer to FIGS. 7A and 7B. FIGS. 7A and 7B depict schematically how the display location moves according to the invention. A moving module 19 of the zoom display system 10 is used to change the display location of the display contents (step 190). Suppose the display location of the display contents is initially at the word ‘a’ in the display contents. The display result is as shown in FIG. 7A.

The moving parameter received by the receiving module 12 is ‘move one character each second’. After 2 seconds, the display location of the display contents is set to be at the word ‘book’ of the display contents. The display result is as shown in FIG. 7B. From the drawings, it is clear to see that the display location of the zoom window is changed at the same time the display contents are changed. The above is only one example, and should not be used to limit the range of the moving parameter.

In summary, differs from the prior art in the following aspects. The invention directly obtains the zoom data by setting the display parameter in the original data of a document file according to the zoom ratio. An appropriate decoding method for the document file is used to decode the zoom data into display contents. Since the original data of the document file are directly zoomed, the invention can zoom differently for different document files. This prevents distortion of the original data in the document file after zooming.

Using the above-mentioned technique, the invention achieves the goal of performing different zooms for contents of different document files. This solves the image distortion problem due to zooming the screen in the prior art.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A display system for zooming document file contents resident in an operating system (OS), comprising:
a path extracting module for extracting a file path of a document file;
a receiving module for receiving a zoom command;
a zooming module for obtaining original data of the document file following the file path of the document file after receiving the zoom command and setting the display parameter of the original data of the document file according to a zoom ratio to obtain zoom data;
a decoding module for selecting a decoding method for the document file and decoding the zoom data into display contents;
a cursor extracting module for extracting a cursor location in the document file and finding a display location of the display contents corresponding to the cursor location;
a display processing module for selecting a display range using the display location and extracting the display contents in the display range as extraction contents; and
a display module for displaying a zoom window of the size of the display range at the cursor location and displaying the extraction contents in the zoom window.

2. The display system for zooming document file contents of claim 1 further comprising a setting module for setting the zoom ratio according to a zoom parameter received by the receiving module.

3. The display system for zooming document file contents of claim 1 further comprising a moving module for changing the display location according to a moving parameter received by the receiving module.

4. A display method for zooming document file contents resident in an OS, comprising the steps of:
extracting a file path of a document file;
receiving a zoom command;
obtaining original data of the document file according to the file path of the document file after receiving the zoom command, and setting the display parameter of the original data of the document file according to a zoom ratio to obtain zoom data;
selecting a decoding method for the document file and decoding the zoom data into display contents;
extracting a cursor location in the document file and finding a display location of the display contents corresponding to the cursor location;
selecting a display range using the display location and extracting the display contents in the display range as extraction contents; and
displaying a zoom window of the size of the display range at the cursor location and displaying the extraction contents in the zoom window.

5. The display method for zooming document file contents of claim 4 further comprising the step of receiving a zoom parameter and using the zoom parameter to set the zoom ratio.

6. The display method for zooming document file contents of claim 4 further comprising the step of receiving a moving parameter and using the moving parameter to change the display location.
